(19) United States
(12) Patent Application Publication
(10) Pub. No.: US 2008/0062046 A1
(43) Pub. Date: Mar. 13, 2008

(54) MOUNTING STRUCTURE FOR MATCHING AN RF INTEGRATED CIRCUIT WITH AN ANTENNA AND RFID DEVICE IMPLEMENTING SAME

(75) Inventor: Tareef Ibrahim Al-Mahdawi, San Jose, CA (US)

Correspondence Address: Zilka-Kotab, PC, P.O. BOX 721120, SAN JOSE, CA, 95172-1120, US

(73) Assignee: INTELLEFLEX CORPORATION

(21) Appl. No.: 11/530,425

(22) Filed: Sep. 8, 2006

(51) Int. Cl. H01Q 1/38; H01Q 1/50

(52) U.S. Cl. 343/700 MS; 343/850

(57) ABSTRACT

A radio frequency device such as an RFID tag according to one embodiment includes an antenna, an integrated circuit, and a structure positioned between the antenna and the integrated circuit for electrically coupling the antenna to the integrated circuit, the structure assisting in matching RF-related properties of the integrated circuit, e.g., antenna inputs thereof, and the antenna.

### FIELD OF THE INVENTION

The present invention relates to Radio Frequency-(RF-)based systems and methods, and more particularly, this invention relates to a mounting structure for matching an integrated circuit to an antenna.

### BACKGROUND OF THE INVENTION

Automatic identification (“Auto-ID”) technology is used to help machines identify objects and capture data automatically. One of the earliest Auto-ID technologies was the bar code, which uses an alternating series of thin and wide bands that can be digitally interpreted by an optical scanner. This technology gained widespread adoption and near-universal acceptance with the designation of the Universal Product Code (“UPC”)—a standard governed by an industry-wide consortium called the Uniform Code Council. Formally adopted in 1973, the UPC is one of the most ubiquitous symbols present on virtually all manufactured goods today and has allowed for enormous efficiency in the tracking of goods through the manufacturing, supply, and distribution of various goods.

However, the bar code still requires manual interrogation by a human operator to scan each tagged object individually with a scanner. This is a line-of-sight process that has inherent limitations in speed and reliability. In addition, the UPC bar codes only allow for manufacturer and product type information to be encoded into the barcode, not the unique item's serial number. The bar code on one milk carton is the same as every other, making it impossible to count objects or individually check expiration dates, much less find one particular carton of many.

Currently, retail items are marked with barcode labels. These printed labels have over 40 “standard” layouts, can be mis-printed, smeared, mis-positioned and mis-labeled. In transit, these outer labels are often damaged or lost. Upon receipt, the pallets typically have to be broken-down and each case scanned into an enterprise system. Error rates at each point in the supply chain have been 4-18% thus creating a billion dollar inventory visibility problem. However, Radio Frequency Identification (RFID) allows the physical layer of actual goods to automatically be tied into software applications, to provide accurate tracking.

The emerging RFID technology employs a Radio Frequency (RF) wireless link and ultra-small embedded computer chips, to overcome these barcode limitations. RFID technology allows physical objects to be identified and tracked via these wireless “tags”. It functions like a bar code that communicates to the reader automatically without needing manual line-of-sight scanning or singulation of the objects.

As in any industry, a goal of RFID designers and manufacturers is to provide low cost tags with high reliability. While the tag circuitry is typically thought of as the most expensive part of the tag, the antenna is also an expensive component. What makes the antenna of an RFID tag expensive and complex is that the antenna must be designed to match the circuitry, or vice versa. If the materials don't match, not only will environmental changes affect performance, making it irregular, but the use of less stable materials results in variations of conductance, capacitance, and inductance from device to device due to inherent manufacturing variations. Thus, the antenna is typically designed with a specific shape and with expensive materials to provide the best RF matching to the circuitry.

What is needed is a way to reduce the dependence upon antenna design, e.g., shape and materials, to provide RF matching between the circuitry and the antenna.

### SUMMARY OF THE INVENTION

radio frequency device such as an RFID tag according to one embodiment includes an antenna, an integrated circuit, and a structure positioned between the antenna and the integrated circuit for electrically coupling the antenna to the integrated circuit, the structure assisting in matching RF-related properties of the integrated circuit, e.g., antenna inputs thereof, and the antenna.

The integrated circuit may be embodied in a chip, which in turn may be mounted to the structure.

The structure according to one embodiment includes a base and electrically conductive traces passing over a surface of the base, the traces being for coupling the antenna to the integrated circuit, the traces providing the matching of the RF-related properties.

The structure according to another embodiment includes a base and electrically conductive traces passing through the base, the traces being for coupling the antenna to the integrated circuit, the traces providing the matching of the RF-related properties.

The structure may assist in matching an impedance of the integrated circuit to the antenna. For example, the structure may generate an inductance.

In another embodiment, the traces have physical shapes that create an impedance therein.

In yet another embodiment, the structure assist in transmission line matching between the integrated circuit and the antenna.

The structure may even include one or more analog components for assisting in the matching.

Other aspects and advantages of the present invention will become apparent from the following detailed description, which, when taken in conjunction with the drawings, illustrate by way of example the principles of the invention.

### BRIEF DESCRIPTION OF THE DRAWINGS

For a fuller understanding of the nature and advantages of the present invention, as well as the preferred mode of use, reference should be made to the following detailed description read in conjunction with the accompanying drawings.

FIG. 1 is a system diagram of an RFID system according to one embodiment of the present invention.

FIG. 2 is a system diagram for an integrated circuit (IC) chip for implementation in an RFID tag.

FIG. 3 is a side view of an RF device according to one embodiment of the present invention.

FIG. 4 is a side view of a structure according to one embodiment of the present invention.

FIG. 5 is a side view of a structure according to another embodiment of the present invention.

### BEST MODE FOR CARRYING OUT THE INVENTION

The following description is the best mode presently contemplated for carrying out the present invention. This description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and as defined in dictionaries, treatises, etc.

The use of RFID tags are quickly gaining popularity for use in the monitoring and tracking of an item. RFID technology allows a user to remotely store and retrieve data in connection with an item utilizing a small, unobtrusive tag. As an RFID tag operates in the radio frequency (RF) portion of the electromagnetic spectrum, an electromagnetic or electrostatic coupling can occur between an RFID tag affixed to an item and an RFID tag reader. This coupling is advantageous, as it precludes the need for a direct contact or line of sight connection between the tag and the reader.

Utilizing an RFID tag, an item may be tagged at a period when the initial properties of the item are known. For example, this first tagging of the item may correspond with the beginning of the manufacturing process, or may occur as an item is first packaged for delivery. Electronically tagging the item allows for subsequent electronic exchanges of information between the tagged item and a user, wherein a user may read information stored within the tag and may additionally write information to the tag.

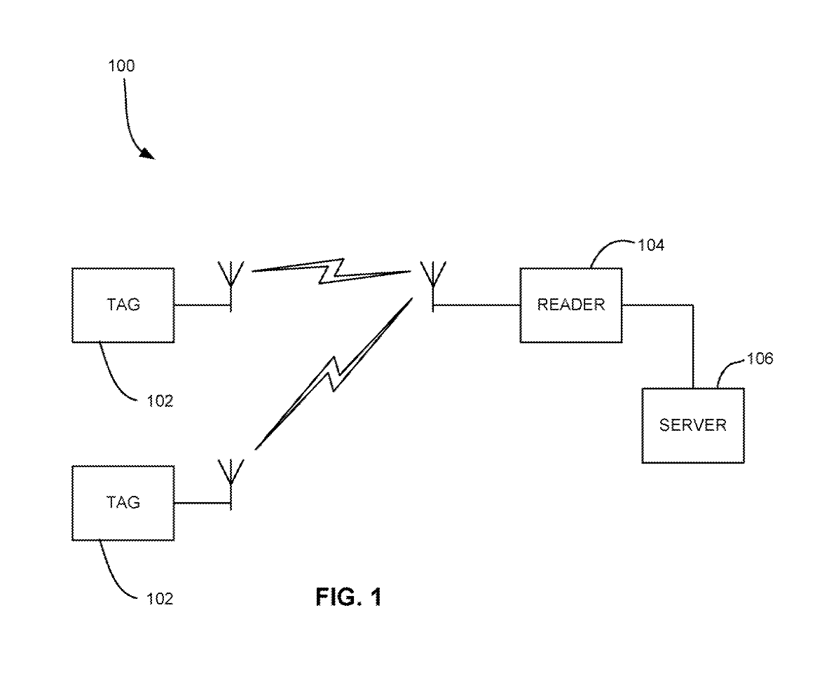

As shown in FIG. 1, an RFID system 100 according to one embodiment of the present invention includes RFID tags 102, an interrogator or “reader” 104, and an optional server 106 or other backend system which may include databases containing information relating to RFID tags and/or tagged items. Each tag 102 may be coupled to an object. Each tag 102 includes a chip and an antenna. The chip includes a digital decoder needed to execute the computer commands that the tag 102 receives from the reader 104. The chip may also include a power supply circuit to extract and regulate power from the RF reader, a detector to decode signals from the reader, a backscatter modulator, a transmitter to send data back to the reader; anti-collision protocol circuits; and at least enough memory to store its unique identification code, e.g., Electronic Product Code (EPC).

The EPC is a simple, compact identifier that uniquely identifies objects (items, cases, pallets, locations, etc.) in the supply chain. The EPC is built around a basic hierarchial idea that can be used to express a wide variety of different, existing numbering systems, like the EAN.UCC System Keys, UID, VIN, and other numbering systems. Like many current numbering schemes used in commerce, the EPC is divided into numbers that identify the manufacturer and product type. In addition, the EPC uses an extra set of digits, a serial number, to identify unique items. A typical EPC number contains:
1. Header, which identifies the length, type, structure, version and generation of EPC;
2. Manager Number, which identifies the company or company entity;
3. Object Class, similar to a stock keeping unit or SKU; and
4. Serial Number, which is the specific instance of the Object Class being tagged.

### Additional fields may also be used as part of the EPC in order to properly encode and decode information from different numbering systems into their native (human-readable) forms.

Each tag 102 may also store information about the item to which coupled, including but not limited to a name or type of item, serial number of the item, date of manufacture, place of manufacture, owner identification, origin and/or destination information, expiration date, composition, information relating to or assigned by governmental agencies and regulations, etc. Furthermore, data relating to an item can be stored in one or more databases linked to the RFID tag. These databases do not reside on the tag, but rather are linked to the tag through a unique identifier(s) or reference key(s).

Communication begins with a reader 104 sending out signals via radio wave to find a tag 102. When the radio wave hits the tag 102 and the tag 102 recognizes and responds to the read's signal, the reader 104 decodes the data programmed into the tag 102. The information is then passed to a server 106 for processing, storage, and/or propagation to another computing device. By tagging a variety of items, information about the nature and location of goods can be known instantly and automatically.

Many RFID systems use reflected or “backscattered” radio frequency (RF) waves to transmit information from the tag 102 to the reader 104. Since passive (Class-1 and Class-2) tags get all of their power from the read signal, the tags are only powered when in the beam of the reader 104.

The Auto ID Center EPC-Compliant tag classes are set forth below:

Class-1
Identity tags (RF user programmable, range ˜3 m)
Lowest cost

Class-2
Memory tags (20 bit address space programmable at ˜3 m range)
Security & privacy protection
Low cost

Class-3
Semi-passive tags (also called semi-active tags)
Battery tags (256 bits to 2M words)
Self-Powered Backscatter (internal clock, sensor interface support)
˜100 meter range
Moderate cost

Class-4
Active tags
Active transmission (permits tag-speaks-first operating modes)
˜30,000 meter range
Higher cost

In RFID systems where passive receivers (i.e., Class-1 and Class-2 tags) are able to capture enough energy from the transmitted RF to power the device, no batteries are necessary. In systems where distance prevents powering a device in this manner, an alternative power source must be used. For these “alternate” systems (also known as semi-active or semi-passive), batteries are the most common form of power. This greatly increases read range, and the reliability of tag reads, because the tag does not need power from the read to respond. Class-3 tags only need a 5 mV signal from the reader in comparison to the 500 mV that Class-1 and Class-2 tags typically need to operate. This 100:1 reduction in power requirement along with the reader's ability to sense a very small backscattered signal enables the tag permits Class-3 tags to operate out to a free space distance of 100 meters or more compared with a Class-1 range of only about 3 meters. Note that semi-passive and active tags with build in passive mode may also operate in passive mode, using only energy captured from an incoming RF signal to operate and respond.

Active, semi-passive and passive RFID tags may operate within various regions of the radio frequency spectrum. Low-frequency (30 KHz to 500 KHz) tags have low system costs and are limited to short reading ranges. Low frequency tags may be used in security access and animal identification applications for example. Ultra high-frequency (860 MHz to 960 MHz and 2.4 GHz to 2.5 GHz) tags offer increased read ranges and high reading speeds. One illustrative application of ultra high-frequency tags is automated toll collection on highways and interstates.

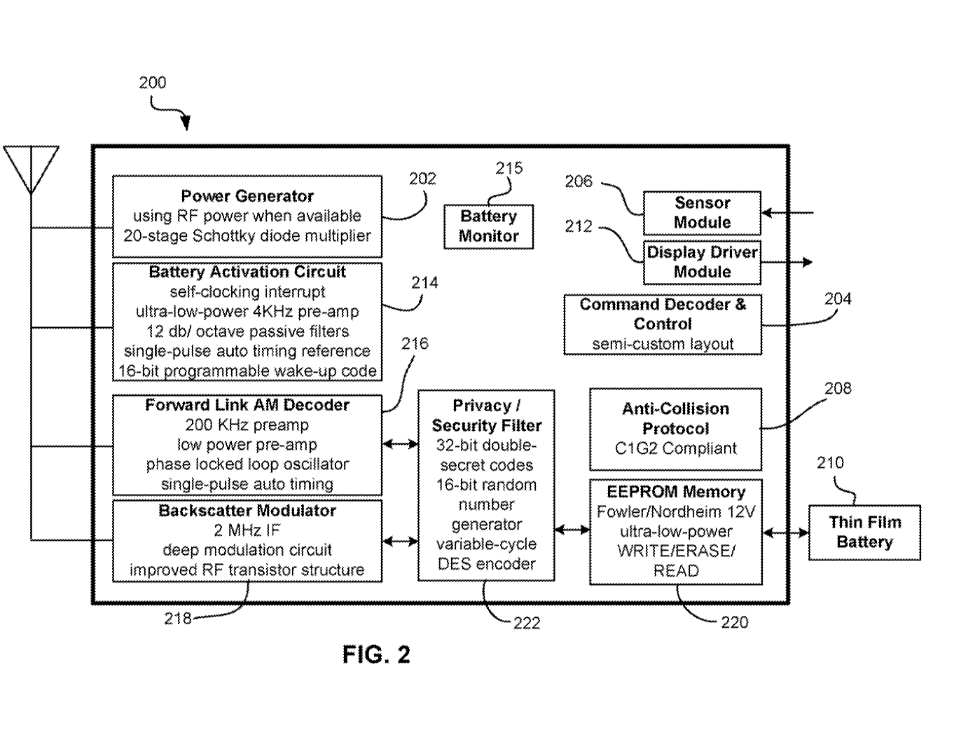

Embodiments of the present invention are preferably implemented in a Class-3 or higher Class chip, which typically contains the control circuitry for most if not all tag operations. FIG. 2 depicts a circuit layout of a Class-3 chip 200 and the various control circuitry according to an illustrative embodiment for implementation in an RFID tag. This Class-3 chip can form the core of RFID chips appropriate for many applications such as identification of pallets, cartons, containers, vehicles, or anything where a range of more than 2-3 meters is desired. As shown, the chip 200 includes several circuits including a power generation and regulation circuit 202, a digital command decoder and control circuit 204, a sensor interface module 206, a C1G2 interface protocol circuit 208, and a power source (battery) 210. A display driver module 212 can be added to drive a display.

A battery activation circuit 214 is also present to act as a wake-up trigger. In brief, many portions of the chip 200 remain in hibernate state during periods of inactivity. A hibernate state may mean a low power state, or a no power state. The battery activation circuit 214 remains active and processes incoming signals to determine whether any of the signals contain an activate command. If one signal does contain a valid activate command, additional portions of the chip 200 are wakened from the hibernate state, and communication with the read can commence. In one embodiment, the battery activation circuit 214 includes an ultra-low-power, narrow-bandwidth preamplifier with an ultra low power static current drain. The battery activation circuit 214 also includes a self-clocking interrupt circuit and uses an innovative user-programmable digital wake-up code. The battery activation circuit 214 draws less power during its sleeping state and is much better protected against both accidental and malicious false wake-up trigger events that otherwise would lead to pre-mature exhaustion of the Class-3 tag battery 210.

A battery monitor 215 can be provided to monitor power usage in the device. The information collected can then be used to estimate a useful remaining life of the battery.

A forward link AM decoder 216 uses a simplified phase-lock-loop oscillator that requires an absolute minimum amount of chip area. Preferably, the circuit 216 requires only a minimum string of reference pulses.

A backscatter modulator block 218 preferably increases the backscatter modulation depth to more than 50%.

A memory cell, e.g., EEPROM, is also present. In one embodiment, a pure, Fowler-Nordheim direct-tunneling-through-oxide mechanism 220 is present to reduce both the WRITE and ERASE currents to about 2 μA/cell in the EEPROM memory array. Unlike any RFID tags built to date, this will permit designing of tags to operate at maximum range even when WRITE and ERASE operations are being performed. In other embodiments, the WRITE and ERASE currents may be higher or lower, depending on the type of memory used and its requirements.

The module 200 may also incorporate a highly-simplified, yet very effective, security encryption circuit 222. Other security schemes, secret handshakes with readers, etc. can be used.

Only six connection pads (not shown) are required for the illustrative chip 200 of FIG. 2 to function: Vdd to the battery, ground, plus two antenna leads to support multi-element omni-directional and isotopic antennas. Sensors to monitor temperature, shock, tampering, etc. can be added by appending an industry-standard I²C or SPI interface to the core chip.

It should be kept in mind that the present invention can be implemented using any type of tag, and the circuit 200 described above is presented as only one possible implementation.

Many types of devices can take advantage of the embodiments disclosed herein, including but not limited to RFID systems and other wireless devices/systems. To provide a context, and to aid in understanding the embodiments of the invention, much of the present description has been presented in terms of an RFID system such as that shown in FIG. 1. It should be kept in mind that this is done by way of example only, and the invention is not to be limited to RFID systems, as one skilled in the art will appreciate how to implement the teachings herein into electronics devices in hardware and/or software. In other words, the invention can be implemented entirely in hardware, entirely in software, or a combination of the two. Examples of hardware included Application Specific Integrated Circuits (ASICs), printed circuits, monolithic circuits, reconfigurable hardware such as Field Programmable Gate Arrays (FPGAs), etc. The invention can also be provided in the form of a computer program product comprising a computer readable medium having computer code thereon. A computer readable medium can include any medium capable of storing computer code thereon for use by a computer, including optical media such as read only and writeable CD and DVD, magnetic memory, semiconductor memory (e.g., FLASH memory and other portable memory cards, etc.), etc. Further, such software can be downloadable or otherwise transferable from one computing device to another via network, wireless link, nonvolatile memory device, etc.

As mentioned above, it is desirable to match a circuit of an RF device to the antenna. Such matching provides maximum signal, maximum data transfer rate, stable operation, etc. Accordingly, one embodiment of the present invention is an RFID device such as an RF tag that includes an antenna, an integrated circuit, and a structure positioned between the antenna and the integrated circuit for electrically coupling the antenna to the integrated circuit, the structure assisting in matching RF-related properties of the integrated circuit and the antenna.

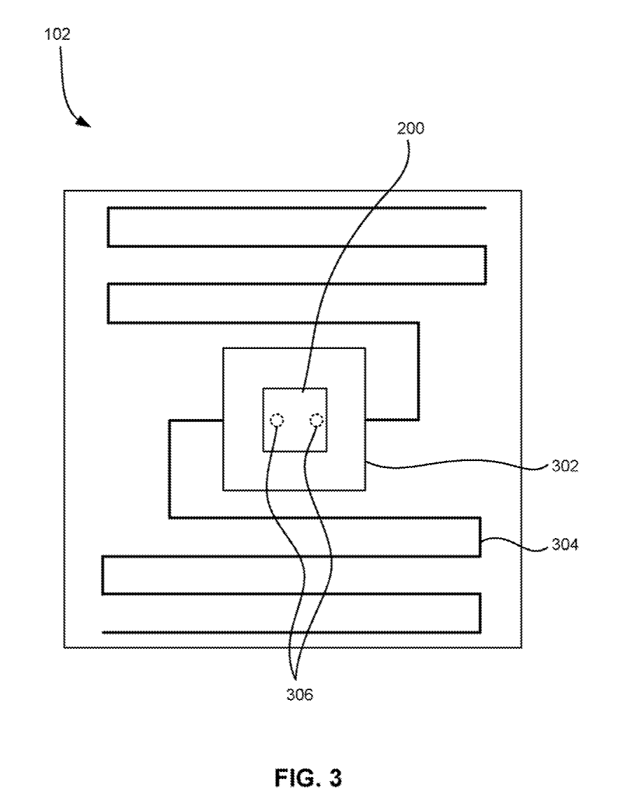

FIG. 3 illustrates an RF device 102, according to one embodiment. As shown, the device 102 includes an integrated circuit 200 mounted on a structure 302 configured as an interposer, such that antenna inputs 306 of the integrated circuit 200 are in contact with pads of the structure 302. Any other components supporting the functionality of the device 102 may also be coupled to/integrated into the structure 302. Such components may include, for example, a battery, a sensor, ground plane, etc.

The subassembly of the structure 302 and integrated circuit 200 is coupled to a base circuit substrate to form the device 102. In a preferred embodiment, the subassembly is adhered to a thin metallic film antenna 304 to form an RFID tag. The antenna 304 (or a similar circuit made from metallized film or other metallized flex circuit) can be made from a thin etched or stamped foil, typically manufactured from a thin foil of copper, copper-alloy, or nickel-iron alloy by stamping or etching. The etching or stamping creates patterns on strips that become antennas. Other methods of making an antenna include printing a conductive ink.

Any suitable mode of coupling the various components together is acceptable, including soldering, use of anisotropically conductive pressure sensitive adhesive, etc. A pressure sensitive conductive adhesive is preferred for attachment of the structure 302 to the antenna 304 or similar circuit, and a different adhesive can be used to attach the integrated circuit 200 to the structure 302, such as a conductive hot melt.

Again, the structure 302 assists in matching RF-related properties of the integrated circuit 200 and the antenna 304. Such properties may include one or more of impedance, conductance and capacitance. The structure may also provide transmission line matching, among other types.

In one embodiment, the structure may assist in matching the antenna inputs 306 of the integrated circuit 200 and the antenna 304 due to a particular shape of its traces, material(s) of construction, presence of analog components, or combination thereof.

In another embodiment, the structure may create or simulate inductance to compensate for capacitance of the integrated circuit due to a particular shape of its traces, material(s) of construction, presence of analog components, or combination thereof. For instance, the antenna has very little impedance while the impedance on the integrated circuit chip is primarily capacitive. The structure may compensate for this via an inductor, materials of construction, etc.

In yet another embodiment, if a response would otherwise drift in one direction, the structure stabilizes the drift.

Because the structure described herein provides stable matching between the integrated circuit and the antenna, antenna design may be greatly simplified. Particularly, matching considerations may be significantly removed from antenna build. For instance, the antenna does not need to have a complex design to provide impedance matching, and so design time is reduced. Also, the antenna may be constructed of very inexpensive materials, thereby significantly reducing the overall cost of the device. Further, the structure provides wider tolerances for antenna manufacturing variations, which also reduces fabrication costs.

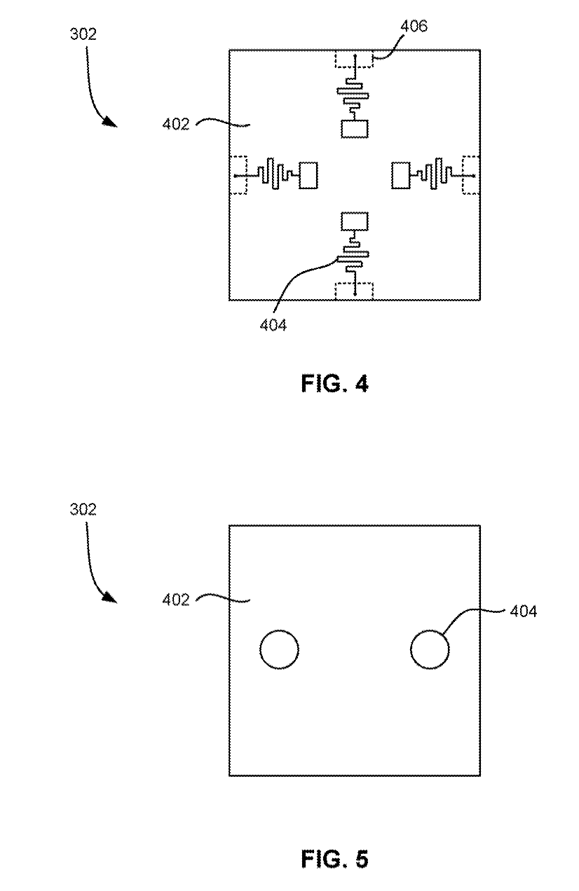

FIG. 4 illustrates a structure 302 according to one embodiment. As shown, the structure includes a base 402 and, in this example, four electrically conductive traces 404 passing over a surface of the base 402. The traces 404 are conductors that may have a specific shape, be formed of a high quality material such as copper or gold, and/or have analog components such as capacitors, inductors, resistors, transistors, etc. that assists in matching of RF-related properties of the integrated circuit to the antenna, or vice versa. For example, the traces may have a specific shape that creates a certain impedance. The structure 302 may also include footprints 406 that allow its mounting to the antenna 304.

FIG. 5 illustrates a structure 302 according to another embodiment. As shown, the structure includes a base 402 and, in this example, two electrically conductive traces 404 passing through the base 402 to pads (not shown) on the bottom of the base for coupling to (or contact with) the antenna. The traces 404 are conductors that may have a specific shape, be formed of a high quality material such as copper or gold, and/or have analog components such as capacitors, inductors, resistors, transistors, etc. that assists in matching of RF-related properties of the integrated circuit to the antenna, or vice versa.

The base of the structure in any of these embodiments is preferably constructed of a dielectric material, ideally a controlled dielectric material. As known to those skilled in the art, controlled dielectric materials are very expensive. However, the controlled dielectric materials are much more stable in varying environmental conditions, and even exhibits fewer manufacturing variations. Thus, because high quality materials need only be used in the structure and not the antenna, the structure may be of small dimensions relative to the tag as a whole, the benefits provided by the increased stability and matching typically outweigh the cost detriment.

Similarly, the traces are preferably constructed of a high quality material, for similar reasons.

The structure 302 is ideally as small as possible such as 1 inch square or less. The structure 302 preferably has a geometric shape, such as a rectangle or square, that allows for ease of manufacture and assembly.

The structure may include a circuit that assist in the matching. For example, such circuitry may include one or more capacitors, resistors, inductors, etc.

Note that the structure does not need to be configured as an interposer, but rather could surround the integrated circuit, lie along one side thereof, etc.

One skilled in the art will appreciate how the systems and methods presented herein can be applied to a plethora of scenarios and venues, including but not limited to automotive yards, warehouses, construction yards, retail stores, boxcars and trailers, etc. Accordingly, it should be understood that the systems and methods disclosed herein may be used with objects of any type and quantity.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

1. A radio frequency device, comprising:
an antenna;
an integrated circuit; and
a structure positioned between the antenna and the integrated circuit for electrically coupling the antenna to the integrated circuit, the structure assisting in matching RF-related properties of the integrated circuit and the antenna, the structure including electrically conductive traces having physical shapes that create an impedance therein.

2. A device as recited in claim 1, wherein the integrated circuit is embodied in a chip.

3. A device as recited in claim 2, wherein the chip is mounted to the structure.

4. A device as recited in claim 1, wherein the structure assists in matching antenna inputs of the integrated circuit and the antenna.

5. A device as recited in claim 1, wherein the structure further comprises a base and electrically conductive traces passing over a surface of the base, the traces passing over the surface of the base being for coupling the antenna to the integrated circuit, and providing the matching of the RF-related properties.

6. A device as recited in claim 1, wherein the structure further comprises a base, the traces passing through the base, the traces being for coupling the antenna to the integrated circuit, the traces providing the matching of the RF-related properties.

7. A device as recited in claim 1, wherein the structure assists in matching an impedance of the integrated circuit to the antenna.

8. A device as recited in claim 7, wherein the structure generates an inductance.

9. A device as recited in claim 1, wherein the traces assist in providing the matching of the RF-related properties.

10. A device as recited in claim 1, wherein the structure assists in transmission line matching between the integrated circuit and the antenna.

11. A device as recited in claim 1, wherein the structure further comprises an analog component for assisting in the matching.

12. A device as recited in claim 1, wherein the device is an RFID tag.

13. A structure for a radio frequency device, comprising:
a base; and
electrically conductive traces for electrically coupling an antenna to an integrated circuit, the traces assisting in matching RF-related properties of the integrated circuit and the antenna, the traces having physical shapes that create an impedance therein.

14. A device as recited in claim 13, wherein the traces pass over a surface of the base.

15. A device as recited in claim 13, wherein die traces pass through the base.

16. A device as recited in claim 13, wherein the traces assist in matching an impedance of the integrated circuit to the antenna.

17. A device as recited in claim 16, wherein the traces generate an inductance.

18. A device as recited in claim 13, wherein the traces are coupled to one of a capacitor, an inductor, a resistor, and a transistor for assisting in the matching.

19. A device as recited in claim 13, wherein the traces assist in transmission line matching between the integrated circuit and the antenna.

20. A device as recited in claim 13, further comprising an analog component coupled to the traces for assisting in the matching.

21. A structure for assisting in matching RE-related properties of an integrated circuit and an antenna of a radio frequency device, comprising:
a base; and
electrically conductive traces for electrically coupling an antenna to an integrated circuit, the traces having physical shapes that create an impedance therein.

22. A device as recited in claim 21, wherein the traces pass over a surface of the base.

23. A device as recited in claim 21, wherein the traces pass through the base.

24. A device as recited in claim 21, wherein the traces assist in matching an impedance or the integrated circuit to the antenna.

25. A device as recited in claim 24, wherein the traces generate an inductance.

26. A device as recited in claim 21, wherein the traces assist in transmission line matching between the integrated circuit and the antenna.

27. A device as recited in claim 21, further comprising an analog component coupled to the traces for assisting in the matching.

28. A device as recited in claim 1, wherein the antenna includes a thin foil constructed from one of copper, copper-alloy, or nickel-iron alloy.

29. A device as recited in claim 1, wherein the antenna includes conductive ink.
